(19) United States
(12) Patent Application Publication
(10) Pub. No.: US 2003/0149877 A1
(43) Pub. Date: Aug. 7, 2003

(54) Smart card with keypro function

(75) Inventors: Che-Min Liao, Hsinchu (TW); Hsi-Jung Tsai, Hsinchu (TW)

Correspondence Address: BEVER HOFFMAN & HARMS, LLP, TRI-VALLEY OFFICE, 1432 CONCANNON BLVD., BLDG. G, LIVERMORE, CA, 94550, US

(73) Assignee: Winbond Electronics Corporation

(21) Appl. No.: 10/331,098

(22) Filed: Dec. 27, 2002

(30) Foreign Application Priority Data
Jan. 3, 2002 (TW) 091100042

(51) Int. Cl. H04L 9/00

(52) U.S. Cl. 713/172; 713/185

(57) ABSTRACT

The present invention discloses a security system for a software. The security system for a software includes an IC card interface electrically connected to the input/output interface of the computer, and an IC card storing therein a computer authentication signal of the software for reading a user authentication signal sent by the software via the IC card interface, checking if the user authentication signal is consistent with the computer authentication signal, and sending a confirmation signal to initiate the software when the user authentication signal is consistent with the computer authentication signal.

### FIELD OF THE INVENTION

This invention relates to a smart card, and more particularly to a smart card with KeyPro function.

### BACKGROUND OF THE INVENTION

Conventionally, a general application software or game software uses a KeyPro to prevent an inauthentic user to access. The KeyPro stores the special data or ID (key) by an EEPROM (Electrically Erasable Programmable Read-Only Memory). When a user inputs his user authentication data by a user interface (such as keyboard), the computer host can confirm the user is a legal user by checking if the user authentication data is consistent with the authentication data stored in the EEPROM.

However, the authentication data stored in the EEPROM is easy to be copied, and the KeyPro is easy to be decrypted by using a virtual port program. Therefore, the Applicant thinks it is need to provide a storing device with KeyPro function which can prevent an inauthentic user to access the security data so as to protect the software well.

### SUMMARY OF THE INVENTION

It is an object of the present invention to provide a security system for a software by the design of a smart card (a kind of IC cards) with the KeyPro function.

It is another object of the present invention to provide a security checking method for a software by a smart card with KeyPro function.

In accordance with an aspect of the present invention, the security system for a software installed in a computer having an input/output interface includes an IC card interface electrically connected to the input/output interface of the computer, and an IC card storing therein a computer authentication signal of the software for reading a user authentication signal sent by the software via the IC card interface, checking if the user authentication signal is consistent with the computer authentication signal, and sending a confirmation signal to initiate the software when the user authentication signal is consistent with the computer authentication signal.

Preferably, the input/output interface is a printer port.

Preferably, the IC card interface is an IC card reader.

Preferably, the IC card is a smart card.

Preferably, the computer authentication signal comprises at least a serial number of the software.

In accordance with another aspect of the present invention, the security checking method for a software installed in a computer having an input/output interface includes steps of providing an IC card interface electrically connected to the input/output interface of the computer, and providing an IC card storing therein a computer authentication signal of the software, checking if a user authentication signal sent by the software is consistent with the computer authentication signal, and sending a confirmation signal to initiate the software when the user authentication signal is consistent with the computer authentication signal.

The method further includes a step of sending a closing signal to close the software when the user authentication signal is not consistent with the computer authentication signal.

Preferably, the input/output interface is a printer port.

Preferably, the IC card interface is an IC card reader.

Preferably, the IC card is a smart card.

Preferably, the computer authentication signal comprises at least a serial number of the software.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 shows a smart card interface and the data pins thereof; and

FIG. 2 shows the connection mode between the smart card interface and the data pins of the printer port.

### DETAILED DESCRIPTION OF THE PREFERRED EMBODIMENT

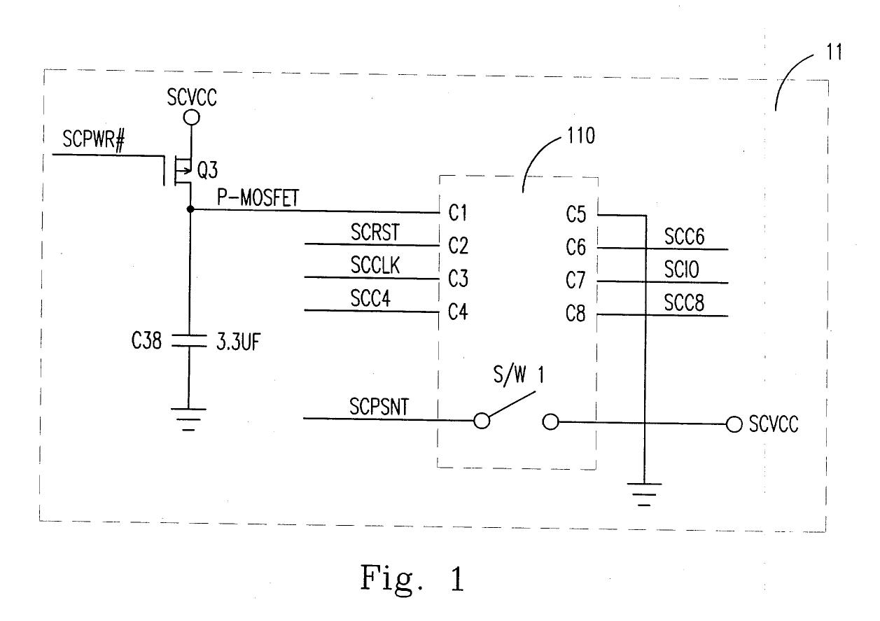

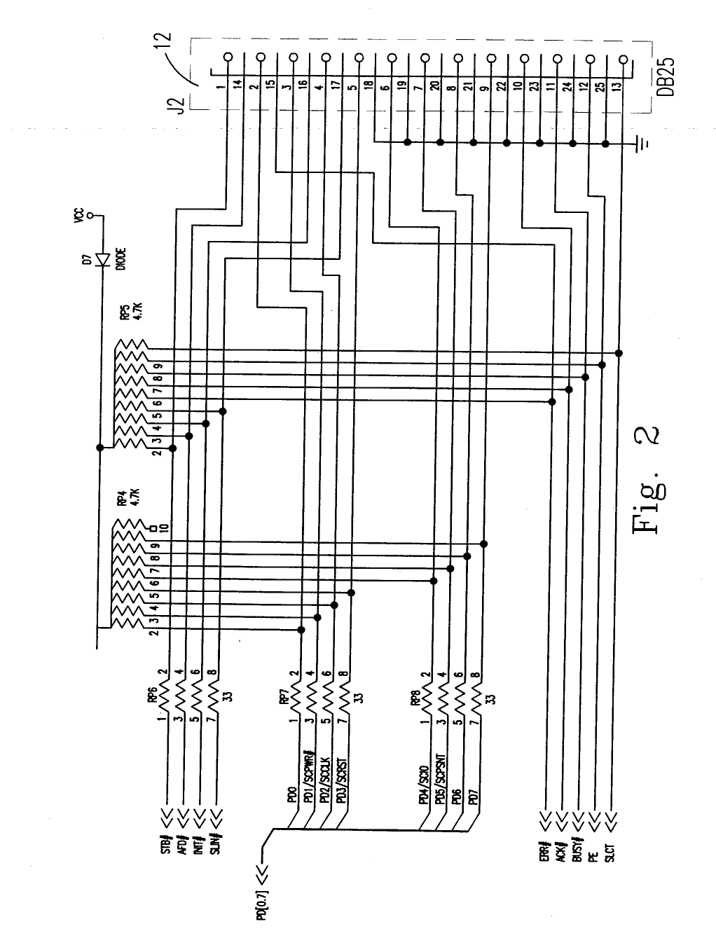

Please refer to FIGS. 1 and 2. According to a preferred embodiment of the present invention, a smart card interface 11 (usually a card reader) is installed on an input/output interface, such as a printer port 12, of a computer host (not shown). The smart card interface 11 has plural GPIO (general purpose input/output) ports in which the seventh GPIO port and the plural data pins thereof are the focus of the present invention. As shown in FIG. 2, portions of the eight data pins (PD0˜PD7) of the printer port 12 are connected to the plural data pins belonged to the seventh GPIO port of the smart card interface 11. The plural data pins belonged to the seventh GPIO port includes a SCPSNT (smart card present detection Schmitt-trigger input, the pin for detecting if the smart card is plugged in the smart card slot 110), a SCIO (smart card data I/O channel, the pin for transmitting data between the smart card and the printer port 12), a SCPWR (smart card power control), a SCCLK (smart card clock output), and a SCRST (smart card reset output), which are electrically connected to the data pins PD5, PD4, PD1, PD2 and PD3 of the printer port 12, respectively. When a software program is initiated on the host, the user authentication signal inputted by the user can be transmitted to the smart card by the software via the PD4 data pin of the printer port 12 and the SCIO data pin of the smart card interface 11.

In the preferred embodiment of the present invention, the smart card includes a memory module (not shown) for storing a computer authentication signal of the software which at least includes a serial number of the software. The smart card further includes a micro-controller (not shown) for reading the user authentication signal transmitted from the printer port 12 via the smart card interface 11, and checking if the user authentication signal is consistent with the computer authentication signal. If it is consistent, the micro-controller will send a confirmation signal to confirm the user is a legal user and initiate the software. If it is inconsistent, the micro-controller will send a close signal to stop the execution of the software. Therefore, the authentication of the user for a software is executed by the smart card through checking the signal responded by the smart card is pass or fail to judge the user's legality.

In conclusion, the smart card of the present invention has the KeyPro function to execute the security checking for a software. The software can judge if the user is a legal user just by checking the response of the smart card is pass or fail, and it doesn't have to worry the authentication data of the software is copied or the KeyPro function is decrypted.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A security system for a software installed in a computer having an input/output interface, comprising:
an IC card interface electrically connected to said input/output interface of said computer; and
an IC card storing therein a computer authentication signal of said software for reading a user authentication signal sent by said software via said IC card interface, checking if said user authentication signal is consistent with said computer authentication signal, and sending a confirmation signal to initiate said software when said user authentication signal is consistent with said computer authentication signal.

2. The system according to claim 1 wherein said input/output interface is a printer port.

3. The system according to claim 1 wherein said IC card interface is an IC card reader.

4. The system according to claim 1 wherein said IC card is a smart card.

5. The system according to claim 1 wherein said computer authentication signal comprises at least a serial number of said software.

6. A security checking method for a software installed in a computer having an input/output interface, comprising steps of:
providing an IC card interface electrically connected to said input/output interface of said computer; and
providing an IC card storing therein a computer authentication signal of said software;
checking if a user authentication signal sent by said software is consistent with said computer authentication signal; and
sending a confirmation signal to initiate said software when said user authentication signal is consistent with said computer authentication signal.

7. The method according to claim 6 further comprising a step of sending a closing signal to close said software when said user authentication signal is not consistent with said computer authentication signal.

8. The method according to claim 6 wherein said input/output interface is a printer port.

9. The method according to claim 6 wherein said IC card interface is an IC card reader.

10. The method according to claim 6 wherein said IC card is a smart card.

11. The method according to claim 6 wherein said computer authentication signal comprises at least a serial number of said software.
